(19) United States
(12) Patent Application Publication
(10) Pub. No.: US 2008/0034534 A1
(43) Pub. Date: Feb. 14, 2008

(54) Quick-release caster assembly

(76) Inventors: Ghassem Zarbi, Abbotsford (CA); Rory Bjarnason, Abbotsford (CA)

Correspondence Address: Adam H. Jacobs;Law Offices of Adam H. Jacobs, Suite 726, 1904 Farnam Street, Omaha, NE, 68102, US

(21) Appl. No.: 11/483,291

(22) Filed: Jul. 7, 2006

(51) Int. Cl. B60B 33/00

(52) U.S. Cl. 16/30

(57) ABSTRACT

A quick-release caster assembly includes a wheel mount caster section having an outwardly extending support strut, at least one wheel rotatably mounted thereon and a connector plate mounted on the inner end thereof. A caster section mounting structure is includes a hollow mounting body having a forward opening, a first engagement plate partially closing a portion of the forward opening and a second engagement plate movably mounted thereon operative to alternatively partially close and open a second portion of the forward opening for releasably retaining the connector plate within the hollow mounting body behind the first and second engagement plates thereby releasably securing the wheel mount caster section on the caster section mounting structure.

### BACKGROUND OF THE INVENTION

1. Technical Field

The present invention relates to caster assemblies and, more particularly, to a quick-release caster assembly for use primarily with floor pressure washing devices, the caster assembly including a wheel mount caster section having an outwardly extending support strut, at least one wheel rotatably mounted on the support strut, and a connector plate mounted on an inner end of the support strut, and a caster section mounting structure mountable on the floor pressure washer which includes a hollow mounting body having a forward opening for receiving the connector plate, a first engagement plate mounted on the hollow mounting body which partially closes a first portion of the forward opening for releasably retaining a first portion of the connector plate within the hollow mounting body, and a second engagement plate movably mounted on the hollow mounting body, the second engagement plate operative to partially close a second portion of the forward opening for releasably retaining a second portion of the connector plate within the hollow mounting body such that the connector plate and hence the wheel mount caster section may be removably mounted on the caster section mounting structure.

2. Description of the Prior Art

Caster assemblies are used in connection with supporting and facilitating movement of many different kinds of objects. Typically, a caster assembly would include at least one wheel rotatably mounted on a lower portion of the caster assembly to engage the floor surface over which the object is being moved and a wheel support structure which is connected to and mounted on the object which supports the wheel below the lower most point of the object. Many different kinds of caster assemblies are used in the prior art, with the vast majority being permanently affixed to the object on which they are mounted. Unfortunately, this permanent affixation of the caster assembly to the particular object is often undesirable, as there are times where disengagement of the caster assembly from the object is required, such as when the object is to be stored in a stationary position or when the object is to be more securely supported by the floor surface on which it is resting. Removal of these caster assemblies is very time-consuming and labor-intensive, and therefore there is a need for caster assemblies which are removable from the object on which they are mounted.

Several different devices have been proposed in the prior art which attempt to address and solve this particular problem, including such devices as Wattron. et al., U.S. Pat. No. 5,594,974, Termini, U.S. Pat. No. 4,719,663, and Powell, U.S. Pat. No. 6,592,133, each of which disclose removably attachable caster wheel assemblies. However, each of the cited prior art devices include inherent deficiencies such as an inability to support relatively heavy loads, an inability to be quickly connected and disconnected from the object on which they are removably mounted, and the requirement of tools to enable the user to remove and replace the caster assembly from the object. There is therefore a need for a quick-release caster assembly which provides a superior solution to the deficiencies found in the prior art.

In particular, power washing devices for floors generally include caster assemblies mounted on the outer edges of the floor-engaging hood which covers and encloses the rotating spray jets which spray the floor surface. At the present time, the caster assembly on such devices are permanently affixed thereto, as there has been an unrecognized need for such removable casters. By permitting the caster assemblies to be removed from the power washer unit, storage of the power washer unit is greatly facilitated as the power washer unit will not accidently roll away from the original storage location at which the device is placed. Also, it has been found that the caster assemblies of such floor cleaning devices often become dirt and grime-encrusted over the lifetime of use of the power washing device. When the caster assemblies are coated in such dirt and grime, the floor cleaning process is rendered more difficult in that the caster assemblies themselves contribute to the degradation in cleanliness of the floor surface. By including removable casters, which are not currently available, the user of the power washing device would need only to remove the caster assemblies, wash the caster assemblies in any available washing location, and replace the caster assemblies on the power washing device, thus eliminating that problem. There is therefore a need for a removable caster assembly for mounting on a floor power washer, which is not currently available in the prior art.

Therefore, an object of the present invention is to provide a quick-release caster assembly for mounting on an object for rollable movement thereof.

Another object of the present invention is to provide a quick-release caster assembly which is particularly designed for mounting on floor pressure washers to facilitate both cleaning and storage of the floor pressure washer.

Another object of the present invention is to provide an improved quick-release caster assembly which includes a wheel mount caster section and a caster section mounting structure, the caster section mounting structure adapted to be mounted on the object to which the caster assembly is to be removably mounted, the wheel mount caster section being releasably mounted within the caster section mounting structure to permit quick removal and replacement of the wheel mount caster section thereon.

Another object of the present invention is to provide an improved quick-release caster assembly which is usable in connection with many different objects merely by mounting the caster section mounting structure on the object.

Finally, an object of the present invention is to provide a quick-release caster assembly which is relatively simple and durable in construction and which is safe, effective and efficient in use.

### SUMMARY OF THE INVENTION

The present invention provides a quick-release caster assembly for mounting on an object for rollable movement thereof which includes a wheel mount caster section having an outwardly extending support strut, at least one wheel rotatably mounted on the support strut and a connector plate mounted on an inner end of the support strut. The caster assembly further includes a caster section mounting structure adapted to be mounted on an object to which the caster assembly is to be removably mounted, the caster section mounting structure including a hollow mounting body having a forward opening for receiving the connector plate of the wheel mount caster section and a first engagement plate mounted on the hollow mounting body for partially closing a first portion of the forward opening thereby releasably retaining a first portion of the connector plate within the hollow mounting body. A second engagement plate is movably mounted on the hollow mounting body, the second engagement plate operative to alternatively partially close and open a second portion of the forward opening for releasably retaining a second portion of the connector plate within the hollow mounting body such that upon the second engagement plate being moved to open the second portion of the forward opening, the connector plate of the wheel mount caster section is insertable and removable through the forward opening of the hollow mounting body. Finally, the first and second engagement plates of the caster section mounting structure cooperate to releasably secure the connector plate of the wheel mount caster section within the hollow mounting body thereby releasably securing the wheel mount caster section on the caster section mounting structure.

The quick-release caster assembly of the present invention as thus described provides a substantial advantage over other caster assemblies found in the prior art. For example, because the caster assembly may be removed from and replaced on the object merely by moving the second engagement plate to release or retain the connector plate within the hollow mounting body, it is extremely simple to remove and replace the wheel mount caster section from the caster section mounting structure, a feature not found in many caster assemblies found in the prior art. Furthermore, because of the design of the releasable connection between the connector plate and the caster section mounting structure, it is highly unlikely that the wheel mount caster section will be accidently dislodged from the caster section mounting structure, thus virtually eliminating the possibility of damage or destruction occurring to the object being supported by the quick-release caster assembly of the present invention. Also, when the present invention is used in connection with floor pressure washers, the quick-release capabilities of the present invention greatly facilitate the cleaning and/or storage of the floor pressure washer, a feature not found in currently available floor pressure washers. It is therefore seen that the quick-release caster assembly of the present invention provides a substantial improvement over those caster assemblies found in the prior art.

### BRIEF DESCRIPTION OF THE DRAWINGS

FIG. 1 is a perspective view of the floor pressure washer unit with a plurality of quick-release caster assemblies mounted on the outer wall thereof;

FIG. 2 is an exploded perspective view of the floor pressure washer unit showing the elements thereof;

FIG. 3 is a detailed side elevational view of the floor pressure washer showing two quick-release caster assemblies mounted thereon;

FIGS. 4 and 5 are detailed side elevational views of the quick-release caster assembly of the present invention which show the wheel mount caster section being held within and released from the caster section mounting structure;

FIG. 6 is a detailed perspective view of the caster section mounting structure mounted on the floor power washing device showing the elements thereof;

FIG. 7 is a detailed top plan view of the caster section mounting structure; and

FIG. 8 is a detailed rear elevational view of the caster section mounting structure having the wheel mount caster section mounted therein.

### DESCRIPTION OF THE PREFERRED EMBODIMENT

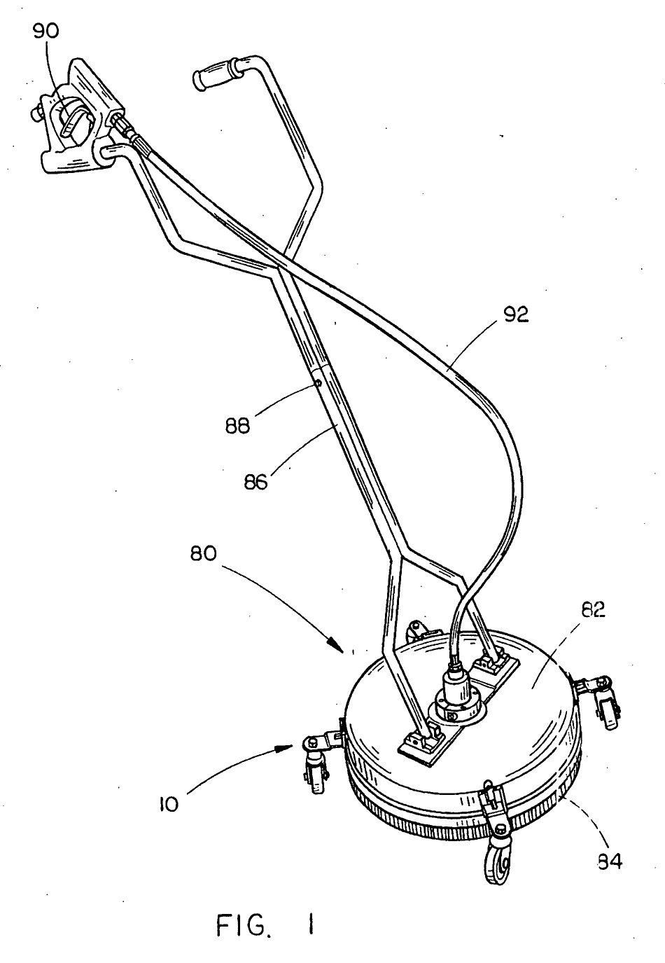

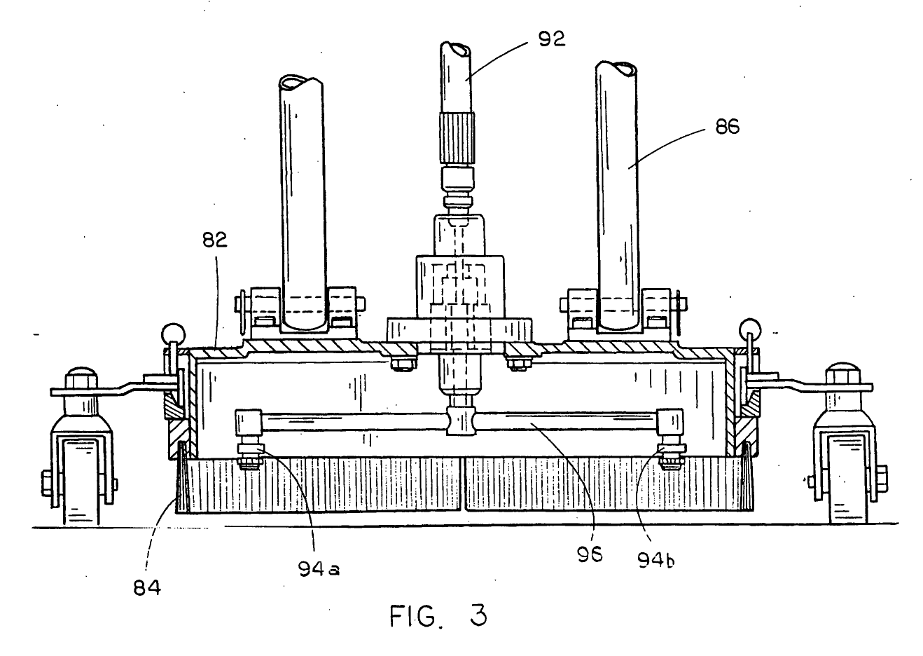

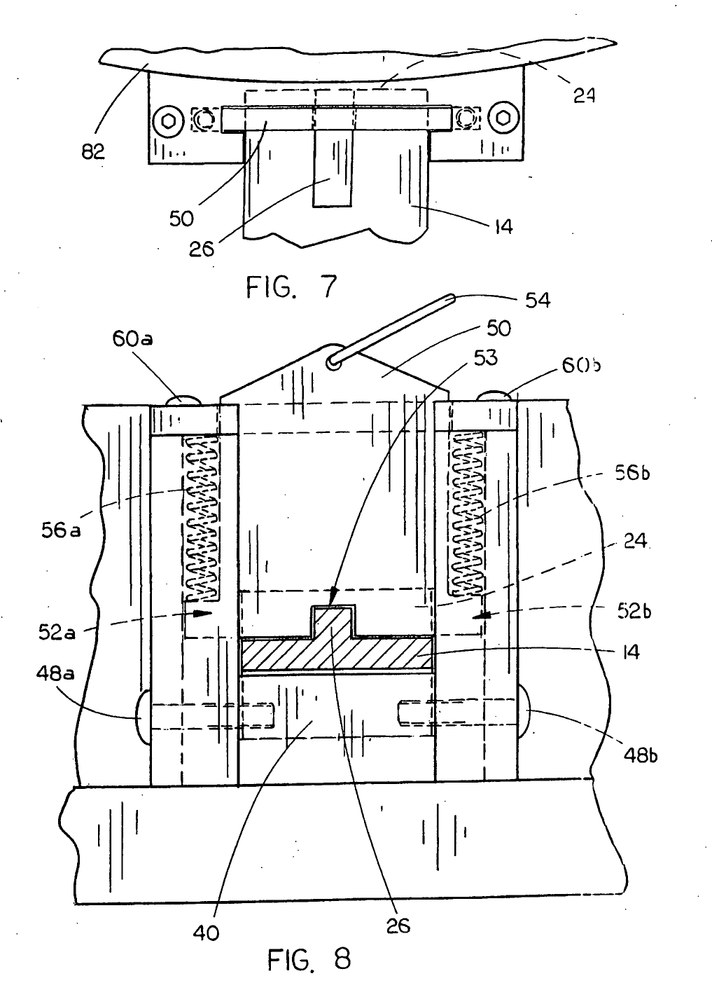

The quick-release caster assembly 10 of the present invention is shown best in FIGS. 1-8 as being mounted on a floor power washing device 80 which would be of a standard type commonly used for power washing and cleaning floor surfaces. As shown herein, the floor power washing device 80 would include a generally cylindrical base cover hood 82 having a diameter of approximately twenty inches to twenty-six inches and a height of approximately three to six inches, the base cover hood 82 being constructed of a PVC plastic-type material. Mounted on and extending downwards from the lower edge of the base cover hood 82 is a circumferential brush curtain 84 which generally prevents water from accidently spraying out from underneath the base cover hood 82 during the cleaning process, the brush curtain 84 being constructed of a plurality of bristles. A handle 86 is pivotally mounted on and extended upwards from the top of base cover hood 82, as shown in FIG. 1, the handle 86 being constructed in two separable pieces connected by a pin 88 or the like, the handle 86 further being constructed of a plastic or metal material which is relatively light in weight. Mounted on handle 86 is a water trigger 90 which, when engaged, permits pressurized water supplied by a water compressor unit (not shown) to flow through the pressurized water hose 92 downwards to the base cover hood 82 and therethrough. Finally, mounted on and positioned underneath the base cover hood 82, as shown best in FIG. 3, are a pair of water nozzles 94a and 94b which are mounted on opposite ends of a rotatably mounted nozzle support tube 96 such that when the pressurized water is released through the hose 92, the pressurized water flows downwards through the hose 92 through the base cover hood 82 into the nozzle support tube 96 and outwards and downwards through nozzles 94a and 94b which, due to their being tilted from vertical approximately ten to twenty degrees, cause the nozzle support tube 96 to rotate in a generally horizontal plane to scour the floor surface 100 over which the floor power washing device 80 is traveling. Of course, the floor power washing device 80 as thus described may be modified or changed in many different ways, as the quick-release caster assemblies 10 of the present invention may be used with virtually any type of floor power washing device 80. However, for informational purposes, a brief summary of the operational aspects of the floor power washing device 80 is deemed beneficial.

As shown best in FIGS. 1, 2 and 3, a plurality of quick-release caster assemblies 10 are used to properly support the base cover hood 82 of the floor power washing device 80. In the preferred embodiment, four of the quick-release caster assemblies 10 would be used to support the base cover hood 82, although it is possible to use as few as three-caster assemblies 10 to support the base cover hood 82. It has been found that the use of four caster assemblies 10, however, provides the best combination of cost-savings and stability in the present invention.

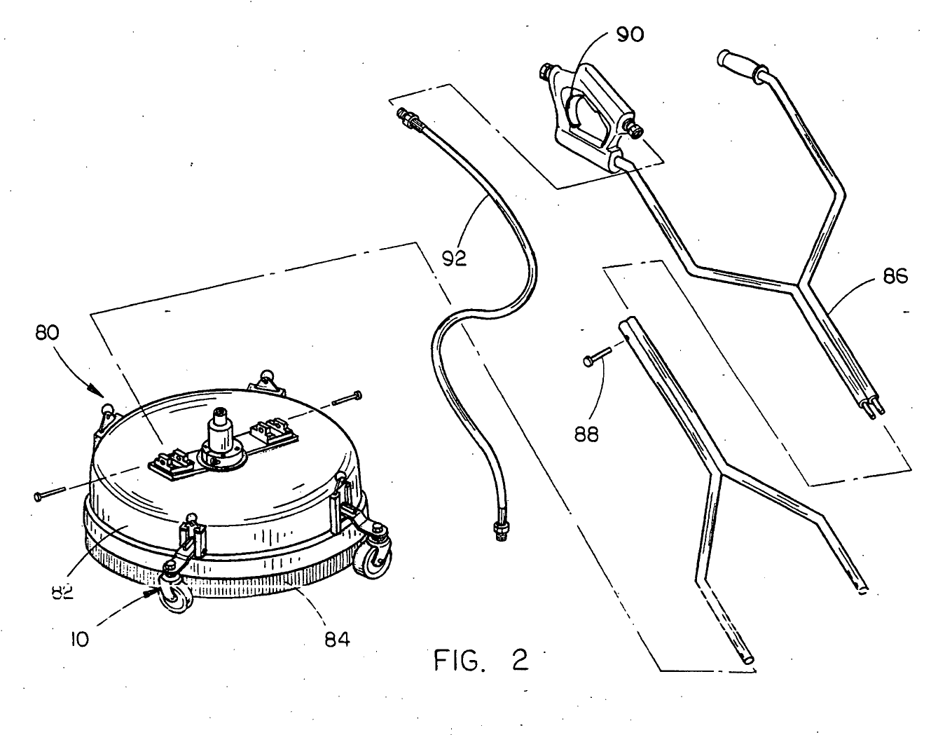

Turning now to the main focus of the present invention, the quick-release caster assembly 10 is shown best in FIGS. 3-8 as including two main sections, the first being a wheel mount caster section 12 and the second being a caster section mounting structure 30. When the quick-release caster assembly 10 of the present invention is used in connection with objects to be supported thereby, the caster section mounting structure 30 would be mounted on the particular object, in this case the floor power washing device 80. As each of the quick-release caster assemblies 10, shown in FIGS. 1 and 2, are generally identical, the following description of a single quick-release caster assembly 10 should be understood to apply equally to any other quick-release caster assemblies which are shown in the drawings.

FIGS. 3, 4 and 5 best disclose particular elements of the wheel mount caster section 12 of the present invention which, in the preferred embodiment, would include an outwardly extending support strut 14 which would preferably be a relatively thick section of metal plate having a length of approximately two to six inches, a width of approximately one-half inch to two inches, and a thickness of approximately one-eighth inch to one-half inch, depending on the load to be carried by the support strut 14 as determined by the object to which the quick-release caster assembly 10 is to be mounted. Mounted on and extending downwards through the support strut 14 adjacent the outer end thereof is a wheel support shaft 16 which extends downwards from support strut 14, as shown best in FIGS. 3, 4 and 5. Rotatably mounted on the lower end of wheel support shaft 16 is a wheel support bracket 18 which would rotatably support a wheel 20 therein. It is expected that the wheel 20 will be mounted on an axle 22 which extends between and connects the lower ends of the wheel support bracket 18, although the exact design of the wheel support bracket 18 is not critical to the present invention, and in fact, so long as the support strut 14 provides a connection point for some type of wheel support device, the wheel mount caster section 12 of the present invention will be able to perform its function in supporting the wheel 20.

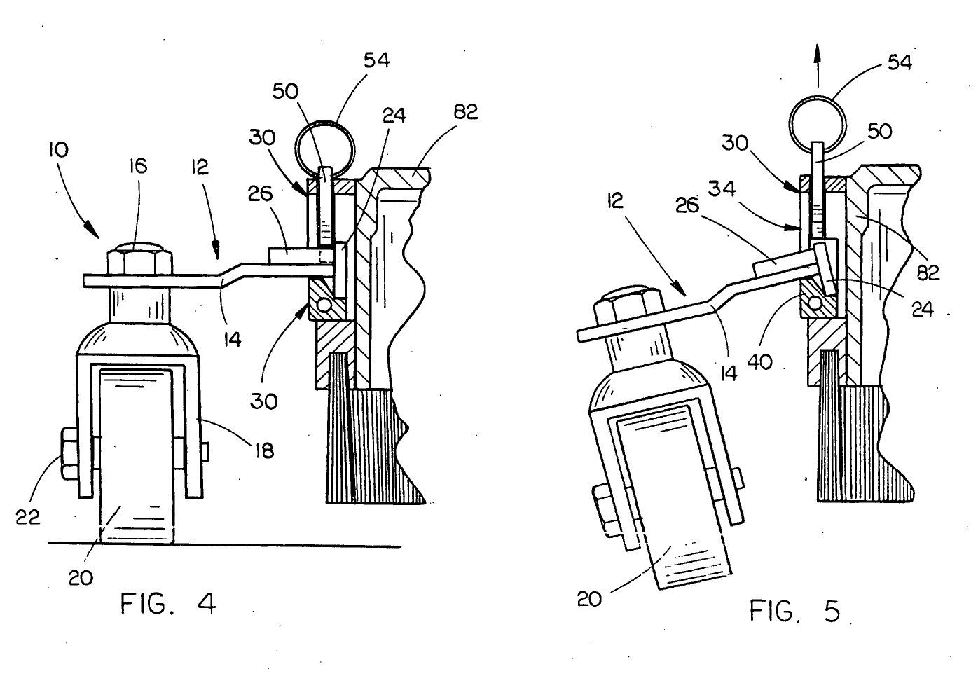

Mounted on the inner end of support strut 14 is a generally rectangular connector plate 24 which extends generally perpendicular to the support strut 14, as shown best in FIGS. 4 and 5. In the preferred embodiment, the connector plate 24 would have a height of approximately one to one-half inches, a width of approximately one-half to one inch, and a thickness of approximately equal to the thickness of support strut 14, with the connection between the support strut 14 and connector plate 24 likely being through a weld or other such metal connection process. To provide additional structural stability to the connection between the support strut 14 and connection plate 24, an upright stabilizing plate 26 extends along the top of the support strut 14 and is connected thereto via welding or the like, and likewise is connected at the inner end thereof to the upper portion of the connector plate 24 via welding or the like in order to provide additional structural stability for the connection between the connection plate 24 and support strut 14. Of course, the precise nature of the stabilizing strut 26 may be modified or changed depending on the particular functional requirements of the present invention which will generally be determined by a series of experiments and tests. The wheel mount caster section 12 has thus been described.

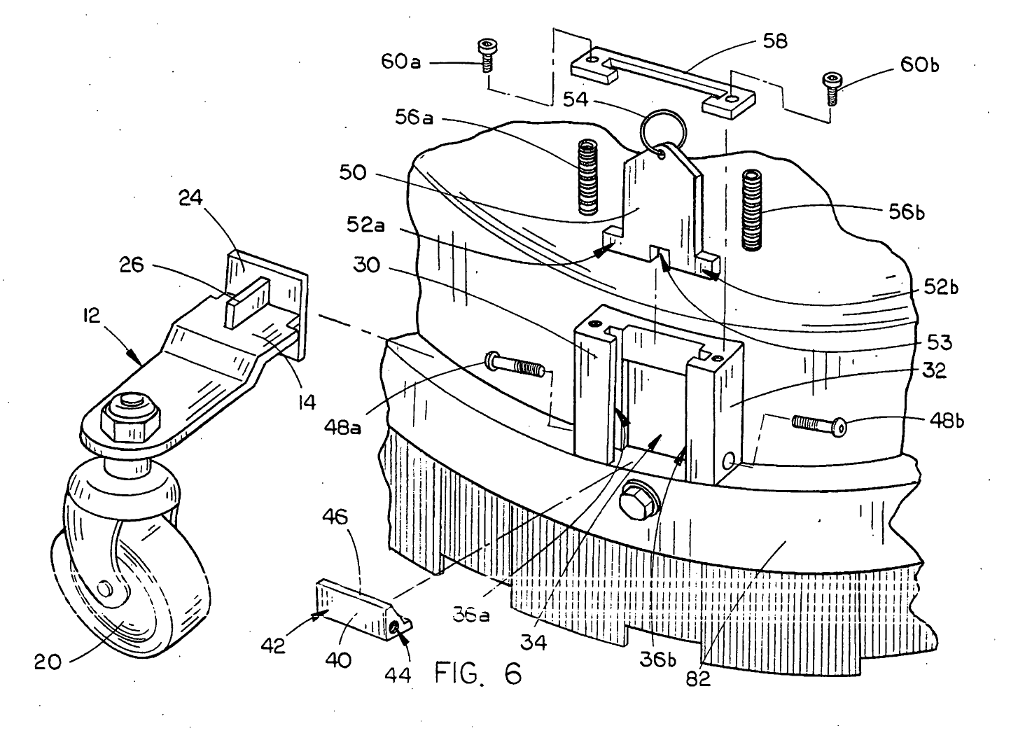

The wheel mount caster section 12 is releasably retained within the caster section mounting structure 30, which is shown best in FIGS. 4-8 as including a generally hollow mounting body 32 which, in the preferred embodiment, would be generally rectangular in shape and would further be generally C-shaped in horizontal cross section. The hollow mounting body 32 would preferably be constructed of a block of metal material such as steel and would either be machined to produce the internal hollow configuration or would be cast via a casting mold to form the shape shown best in FIGS. 6-8. The hollow mounting body 32 would be securely mounted on the base cover hood 82 via bolts or the like and would further include a forward opening 34, left and right upright channels 36a and 36b formed adjacent the forward opening 34 and would also include a plurality of bolt holes through which securement screws and bolts may be extended to secure the various elements of the caster section mounting structure 30 to the hollow mounting body 32.

Mounted on the lower portion of the hollow mounting body 32 and partially covering the forward opening 34 is a first engagement plate 40 which, in the preferred embodiment, would be a generally L-shaped metal block having generally perpendicular base and front walls 42 and 44 and an angled rear wall 46 which extends between and generally connects the edges of the front and base walls 42 and 44, as shown best in FIG. 6. The first engagement plate 40 would be slid into the hollow mounting body 32 through forward opening 34 and secured therein via securement bolts 48a and 48b, as shown in FIGS. 6 and 8, such that a portion of the forward opening 34 is closed by placement of the first engagement plate 40 therein.

Slidably mounted within upright channels 36a and 36b of hollow mounting body 32 is a second engagement plate 50 which, in the preferred embodiment, would consist of a generally rectangular metal plate having left and right lower flanges 52a and 52b which extend outwards generally perpendicular from the second engagement plate 50, as shown best in FIG. 6. These left and right flanges 52a and 52b fit within the upright channels 36a and 36b, as shown in FIG. 8, such that the second engagement plate 50 may be slid up and down within the upright channels 36a and 36b of hollow mounting body 32. Second engagement plate 50 would also include a center notch 53 formed at the base of the second engagement plate 50 and would further include a pull ring 54 or the like which would be mounted at the top of the second engagement plate 50 to facilitate pulling of the second engagement plate 50 upwards within the upright channels 36a and 36b.

In the preferred embodiment, the second engagement plate 50 would be biased downwards by a pair of biasing springs 56a and 56b which would be mounted within a respective one of the upright channels 36a and 36b above the left and right flanges 52a and 52b when the second engagement plate 50 is slidably housed within the hollow mounting body 32. The biasing springs 56a and 56b are preferably coil springs which act to force the second engagement plate 50 downwards relative to the hollow mounting body 32, as shown best in FIG. 8. To secure the biasing springs 56a and 56b within the upright channels 36a and 36b, a generally C-shaped top cover plate 58 is provided along with a pair of securement screws 60a and 60b which secure the biasing springs 56a and 56b and the second engagement plate 50 within the upright channels 36a and 36b of hollow mounting body 32. In this manner, the second engagement plate 50 is slidably housed within the hollow mounting body 32 and is biased downwards to the length of the biasing springs 56a and 56b, as shown best in FIG. 8.

The wheel mount caster section 12 would be secured within the caster section mounting structure 30 in the following manner. The pull ring 54 mounted on second engagement plate 50 would be grasped by the user and biased upwards, as shown in FIG. 5, thus moving the second engagement plate 50 upwards within upright channels 36a and 36b and permitting access to the interior of the hollow mounting body 32 via forward opening 34. At this time, the connector plate 24 of wheel mount caster section 12 would be extended into the forward opening 34 by inserting the lower end of the connector plate 24 into the forward opening 34 first until the lower end of the connector plate 24 contacts the inner portion of first engagement plate 40. The angled configuration of rear wall 46 of first engagement plate 40 permits the connector plate 24 and therefore wheel mount caster section 12 to be tilted, as shown in FIG. 5, to facilitate insertion of the connector plate 24 into the forward opening 34 of hollow mounting body 32. It is further preferred that the connector plate 24 have a slightly smaller width than the width of forward opening 34 so that when the connector plate 24 is placed within the forward opening 34 of hollow mounting body 32, it fits snugly therewithin to reduce undesirable movement of the connector plate 24 relative to hollow mounting body 32.

Once the connector plate 24 is placed within the hollow mounting body 32 through forward opening 34, the wheel mount caster section 12 is tilted upwards to align the connector plate 24 in a generally upright configuration, as shown in FIGS. 4, 7 and 8. The pull ring 54 is then released and the biasing springs 56a and 56b force the second engagement plate 50 downwards within the upright channels 36a and 36b in front of the connector plate 24 until the support strut 12 is sandwiched between the first engagement plate 40 and the second engagement plate 50, as shown in FIG. 8. The notch 53 fits over the stabilizing strut 26 and because the connector plate 24 is securely housed behind the second engagement plate 50 and first engagement plate 40, the wheel mount caster section 12 is securely mounted to the caster section mounting structure 30, as shown best in FIGS. 4 and 8. By reversing the above-described procedure, the wheel mount caster section 12 may be released from the caster section mounting strip 30, and therefore it is seen that it is a relatively simple matter to release and reconnect the wheel mount caster section 12 on the caster section mounting structure 30.

One of the unique features of the present invention when used in connection with a floor power washing device 80 is that when the wheel mount caster section 12 is removed from the caster section mounting structure 30, the floor power washing device 80 can be used to clean walls, instead of being limited to only floor cleaning. Standard floor power washers cannot be used for wall cleaning, due to their permanently mounted caster assemblies, and therefore the usefulness of those devices is restricted. By using the present invention in connection with floor power washing device 80, the potential number and types of uses of such devices is greatly increased, and therefore the present invention provides substantial improvements over caster assemblies currently found in the prior art.

It is to be understood that numerous additions, modifications and substitutions may be made to the quick-release caster assembly 10 of the present invention which fall within the intended broad scope of the appended claims. For example, although the caster section mounting structure 30 has been described with some particularity, modifications to the structure may be undertaken so long as the intended functional feature of providing a slidably mounted second engagement plate 50 which releasably engages the wheel mount caster section 12 is generally maintained. Furthermore, the precise size, shape, and construction materials used in connection with the quick-release caster assembly 10 may be modified or changed so long as the intended functional characteristics of the present invention are maintained. Also, although the quick-release caster assembly 10 of the present invention has been described as being used in connection with a floor power washing device 80, the present invention may be mounted on many different types of objects where use of a caster would be beneficial, and the same functional features which render the quick-release caster assembly 10 ideally suited for use with a floor power washing device 80 would be transferred to the new object, particularly in permitting safe and efficient storage and positioning of the object after movement of the object is no longer required. Finally, it should be noted that although the present invention has been described as being primarily designed for use with a caster which includes at least one wheel, the wheeled caster may be replaced by other support devices such as support legs, skids, runners or other such support structures, any of which may be used with the quick-release caster assembly described herein.

There has therefore been shown and described a quick-release caster assembly 10 which accomplishes at least all of its intended objectives.

We claim:

1. A quick-release caster assembly for mounting on an object for rollable movement thereof comprising;
a wheel mount caster section including;
an outwardly extending support strut;
at least one wheel rotatably mounted on said support strut;
a connector plate mounted on an inner end of said support strut;
a caster section mounting structure adapted to be mounted on an object to which said caster assembly is to be removably mounted, said caster section mounting structure including;
a hollow mounting body having a forward opening for receiving said connector plate of said wheel mount caster section;
a first engagement plate mounted on said hollow mounting body partially closing a first portion of said forward opening for releasably retaining a first portion of said connector plate within said hollow mounting body;
a second engagement plate movably mounted on said hollow mounting body; said second engagement plate operative to alternatively partially close and open a second portion of said forward opening for releasably retaining a second portion of said connector plate within said hollow mounting body such that upon said second engagement plate being moved to open said second portion of said forward opening, said connector plate of said wheel mount caster section is insertable and removable through said forward opening of said hollow mounting body; and
said first and second engagement plates of said caster section mounting structure cooperating to releasably secure said connector plate of said wheel mount caster section within said hollow mounting body thereby releasably securing said wheel mount caster section on said caster section mounting structure.

2. The quick-release caster assembly of claim 1 wherein said first engagement plate comprises a generally L-shaped metal block having generally perpendicular base and front walls and an angled rear wall which extends between and generally connects the edges of the front and base walls.

3. The quick-release caster assembly of claim 1 wherein said hollow mounting body further comprises left and right generally parallel spaced apart upright channels formed adjacent said forward opening within said hollow mounting body.

4. The quick-release caster assembly of claim 3 wherein said second engagement plate comprises a generally rectangular metal plate having left and right lower flanges which extend outwards generally perpendicular from said second engagement plate, said left and right flanges adapted to fit within said upright channels whereby said second engagement plate is slidably mounted within said upright channels of said hollow mounting body.

5. The quick-release caster assembly of claim 1 further comprising at least one biasing spring mounted within said hollow mounting body in operative connection with said second engagement plate for biasing said second engagement plate to partially close said second portion of said forward opening for releasably retaining said second portion of said connector plate within said hollow mounting body.

6. The quick-release caster assembly of claim 1 wherein said connector plate is mounted on said support strut, extends generally perpendicular thereto and is generally rectangular in shape.

7. In combination:
a floor power washing device comprising a generally cylindrical base cover hood, at least one spray nozzle mounted under said base cover hood, handle means mounted on and extending upwards from said base cover hood and trigger means for permitting pressurized liquid flow to said at least one spray nozzle; and
at least one quick-release caster assembly comprising;
a wheel mount caster section including;
an outwardly extending support strut;
at least one wheel rotatably mounted on said support strut;
a connector plate mounted on an inner end of said support strut;
a caster section mounting structure mounted on said base cover hood of said floor power washing device, said caster section mounting structure including;
a hollow mounting body having a forward opening for receiving said connector plate of said wheel mount caster section;
a first engagement plate mounted on said hollow mounting body partially closing a first portion of said forward opening for releasably retaining a first portion of said connector plate within said hollow mounting body;
a second engagement plate movably mounted on said hollow mounting body; said second engagement plate operative to alternatively partially close and open a second portion of said forward opening for releasably retaining a second portion of said connector plate within said hollow mounting body such that upon said second engagement plate being moved to open said second portion of said forward opening, said connector plate of said wheel mount caster section is insertable and removable through said forward opening of said hollow mounting body; and
said first and second engagement plates of said caster section mounting structure cooperating to releasably secure said connector plate of said wheel mount caster section within said hollow mounting body thereby releasably securing said wheel mount caster section on said caster section mounting structure.

8. The combination of claim 7 wherein said first engagement plate comprises a generally L-shaped metal block having generally perpendicular base and front walls and an angled rear wall which extends between and generally connects the edges of the front and base walls.

9. The combination of claim 7 wherein said hollow mounting body further comprises left and right generally parallel spaced apart upright channels formed adjacent said forward opening within said hollow mounting body.

10. The combination of claim 9 wherein said second engagement plate comprises a generally rectangular metal plate having left and right lower flanges which extend outwards generally perpendicular from said second engagement plate, said left and right flanges adapted to fit within said upright channels whereby said second engagement plate is slidably mounted within said upright channels of said hollow mounting body.

11. The combination of claim 7 further comprising at least one biasing spring mounted within said hollow mounting body in operative connection with said second engagement plate for biasing said second engagement plate to partially close said second portion of said forward opening for releasably retaining said second portion of said connector plate within said hollow mounting body.

12. The combination of claim 7 wherein said connector plate is mounted on said support strut, extends generally perpendicular thereto and is generally rectangular in shape.
